(19) United States
(12) Patent Application Publication
(10) Pub. No.: US 2005/0230255 A1
(43) Pub. Date: Oct. 20, 2005

(54) Silver destaining method

(76) Inventors: Lloyd W. Sumner, Ardmore, OK (US); Barbara Wolf-Sumner, Ardmore, OK (US); Victor Asirvatham, Boca Raton, FL (US)

Correspondence Address: Robert E Hanson;Fulbright & Jaworski, Suite 2400, 600 Congress Avenue, Austin, TX, 78701, US

(21) Appl. No.: 10/472,300

(22) PCT Filed: Apr. 1, 2002
(86) PCT No.: PCT/US02/10079

§ 371 Date: Mar. 14, 2005

Related U.S. Application Data
(60) Provisional application No. 60/280,248, filed on Mar. 30, 2001.
(60) Provisional application No. 60/343,815, filed on Dec. 26, 2001.

(51) Int. Cl. G01N 27/447

(52) U.S. Cl. 204/463; 436/177

(57) ABSTRACT

A method for removing transition metal stains from biological samples including protein, DNA, and RNA has been found. In particular, a hydrogen peroxide mediated silver stain removal method for PAGE gels is disclosed which is safer, more effective, and more convenient than other methods of the prior art. This silver destaining method is compatible with mass spectrometry analyses of in gel digested PAGE gels.

### CROSS-REFERENCE TO RELATED APPLICATIONS

This application claims the benefit of U.S. Provisional Patent Application Nos. 60/280,248 filed Mar. 30, 2001 and 60/343,815 filed Dec. 26, 2001.

### TECHNICAL FIELD OF INVENTION

This invention relates to a method of removing silver stain or other transition metal stains from proteins, peptides, RNA and DNA in electrophoresis material.

### BACKGROUND OF THE INVENTION

One-dimensional and two-dimensional polyacrylamide gel electrophoresis (PAGE) are commonly used for separating and profiling proteins from plants, animals, and microorganisms. Silver staining is the most prevalent staining technique for visualizing proteins separated by one-dimensional and two-dimensional PAGE because of its enhanced sensitivity (Shevchenko, et al. 1996. “Mass spectrometric sequencing of proteins silver-stained polyacrylamide gels,” Anal Chem 68:850; Blum, et al. 1987. “Improved silver staining of plant proteins, RNA and DNA in polyacrylamide gels,” Electrophoresis 8:93; Oakley, et al. 1980. “A simplified ultrasensitive silver stain for detecting proteins in polyacrylamide gels,” Anal Biochem 105:361-363; Sammons, et al. 1981. “Ultrasensitive silver-based color staining in polyacrylamide gel,” Electrophoresis 2:135-141).

Recent advances in mass spectrometry and the establishment of genomic and protein databases have substantially increased the ease and speed with which PAGE-isolated proteins can be identified. These techniques include matrix-assisted laser desorption/ionization-mass spectrometry (MALDI-MS) (Karas and Hillenkamp. 1988. “Laser desorption/ionization of proteins with molecular masses exceeding 100,000 daltons,” Anal Chem 60:2299-2301), electrospray ionization mass spectrometry (ESI-MS), (Fenn, et al. 1990. “Electrospray ionization-principles and practice,” Mass Spec Rev 9:37-70), and tandem mass spectrometry (Yates, J. R. III. 1998. “Mass spectrometry and the age of the proteome,” J Mass Spectrom 33:1-19).

Methods of silver staining PAGE-separated proteins compatible with such mass spectrometric techniques have also been reported (Moertz, et al. “Improved silver staining protocols compatible with large-scale protein identification,” Proc 48^{th} ASMS Conf Mass Spectrometry and Applied Topics, Long Beach, Calif., Jun. 11-15,2000; Becklin, et al. “An improved silver-stain method for 2D gel electrophoresis reduces background staining and dramatically increases total number of proteins that are visualized,” Proc 48^{th} ASMS Conf Mass Spectrometry and Applied Topics, Long Beach, Calif., Jun. 11-15, 2000; Moertz, et al. 2000. “Improved silver staining protocols compatible with large-scale protein identification,” Proc 46^{th} ASMS Conference on Mass Spectrometry and Allied Topics, Palm Springs, Calif.). These methods are similar to traditional silver staining techniques but omit the cross-linking agent (usually glutaraldehyde) to ensure maximum proteolytic digestion efficiency and peptide recovery from in-gel digested proteins.

The protocol to identify proteins separated by one- and two-dimensional PAGE includes excising visualized protein bands, digesting the proteins in-gel using a protease (e.g., trypsin), and finally measuring the masses for the resulting cleaved peptides (Shevchenko, et al. 1996. Anal Chem 68:850-858; Blum, et al. 1987. Electrophoresis 8:93; Moertz, et al. Proc 48^{th} American Society for Mass Spectrometry (ASMS) Conference Mass Spectrometry and Applied Topics, Long Beach, Calif., Jun. 11-15, 2000; Pappin, et al. 1993. Curr Biol 3:327; Clauser, et al. 1999. “Role of accurate mass measurement (+/−10 ppm) in protein identification strategies employing MS or MS/MS and database searching,” Anal Chem 71:2871-2882). The observed peptide masses can be searched against a theoretical list of proteolytic peptide maps predicted by a gene or protein database, such as the database maintained by the National Center for Biotechnology Information (NCBI) for protein identification. If the database query is unsuccessful, the protein can be sequenced directly using tandem mass spectrometry (MS/MS) (Yates, J. R., III. 1998. “Mass spectrometry and the age of the proteome,” J Mass Spectrom 33:1-19). During the MS/MS experiment, only the peptide mass of interest is isolated or transmitted, thus discriminating against all other components of the mixture with different mass-to-charge values. After isolation, the peptide is fragmented using a unimolecular or bimolecular (collision gas) strategy. Fragments observed in the isolated peptide can then be rationalized to a sequence or used to search the databases using a “sequence tag” approach.

Although it has been reported that silver stain does not directly bind with proteins (Shevchenko, et al. 1996. “Mass spectrometric sequencing of proteins silver-stained polyacrylamide gels,” Anal Chem 68:850-858), deleterious effects of silver stain on peptide mass fingerprinting have been noted (Scheler, et al. 1998. “Peptide mass fingerprint sequence coverage from differently stained proteins on two-dimensional electrophoresis patterns by matrix assisted laser desorption/ionization-mass spectrometry (MALDI-MS),” Electrophoresis 19:918-927; Otto, et al. 1996. “Identification of human myocardial proteins separated by two-dimensional electrophoresis using an effective sample preparation for mass spectrometry,” Electrophoresis 17:1643-1650; Gharahdaghi, et al. 1999. “Mass spectrometric identification of proteins from silver-stained polyacrylamide gel: a method for the removal of silver ions to enhance sensitivity,” Electrophoresis 20:601-605). Gharahdaghi, et al. demonstrated that removing silver from PAGE gels prior to in-gel digestion enhanced the sensitivity of peptide mapping using matrix-assisted laser desorption/ionization time of flight mass spectrometry (MALDI-TOF-MS) Using Farmer's reducing reagents (1:1 ratio of 30 mM potassium ferricyanide and 100 mM sodium thiosulfate) to reduce the silver stain to a water soluble complex, Gharahdaghi, et al. then removed the water soluble complex by repeatedly washing the PAGE gel pieces prior to enzymatic digestion. The Farmer's reducing process of silver removal includes both redox and complexation chemistry, and the mechanism of silver removal using the Farmer's reagents has been previously reported (Meywald, et al. 1995. “Increased specificity of colloidal silver staining by means of chemical attenuation,” Hereditas 124:63-70). Ferricyanide (III), supplied as its potassium salt, oxidizes silver metal (Ag⁰) to silver ion (Ag⁺) while itself is reduced to ferricyanide (II). Ferricyanide (II) then reacts with silver ions to form an intermediate complex. The presence of sodium thiosulfate provides a sequential path of complexation to a final soluble complex that can then be removed through reiterative rinsings. These reactions are summarized in Table I.

By removing silver stain with Farmer's reducing reagents, the sensitivity of subsequent mass spectrometry analyses was reportedly increased. However, several disadvantages exist with this method. Using potassium ferricyanide with sodium thiosulfate to treat the silver metal in the PAGE gel introduces additional ionic species into the sample which are known to reduce ionization efficiencies in mass spectrometry

TABLE I
Reactions with Farmer's Reagents

| | | | | |
|---|---|---|---|---|
| [³⁺Fe(CN)₆]³⁻ | Ag | [²⁺Fe(CN)₆]⁴⁻ | Ag⁺ | silver oxidation |
| [²⁺Fe(CN)₆]⁴⁻ | 4Ag | Ag₄[²⁺Fe(CN)₆] | | Net reaction |
| 2Ag⁺ | S₂O₃²⁻ | Ag₂S₂O₃ | | insoluble |
| Ag₂S₂O₃ | S₂O₃²⁻ | 2[Ag(S₂O₃)]⁻ | | slightly soluble |
| [Ag(S₂O₃)]⁻ | S₂O₃²⁻ | [Ag(S₂O₃)₂]³⁻ | | soluble |
| Ag⁺ | 2S₂O₃²⁻ | [Ag(S₂O₃)₂]³⁻ | | Net reaction |

techniques such as MALDI-TOF-MS (Bomsen, K. O. 2000. “Influence of salts, buffers, detergents, solvents, and matrices on MALDI-MS protein analysis in complex mixtures,” Methods Mol Biol 146:387-404). Although the excess ionic components can be removed by extensive washing, the washing procedure is laborious and time consuming. Moreover, the toxicity of potassium ferricyanide used as a Farmer's reducing reagent represents a potential hazard for laboratory personnel. Finally, the active Farmer's reducing solution has a very limited solution lifetime of 30 minutes and, therefore, must be made fresh prior to every use to work effectively. Other photographic reducing solutions comprised of copper sulfate and sodium thiosulfate useful in removing silver reportedly have similar disadvantages (Schwitzer, et al. 1979. “A highly sensitive silver stain for detecting proteins and peptides in polyacrylamide gels” Anal Biochem 98:231-237).

New methods of removing transition metal stains (e.g., silver) prior to proteolytic in-gel digestion and mass spectrometric analysis have now been found. In a preferred method, hydrogen peroxide is used as a destaining agent.

### SUMMARY OF INVENTION

In one aspect, the invention is a method to remove transition metal stains from biological products separated from one another by electrophoresis. In another aspect, the invention is a method to remove transition metal stains from biological products within tissue. In each case, the method utilizes an oxidizing reagent to solubilize the transition metal before repeated rinsing with water to remove the metal. Preferably, the method removes silver stain utilizing hydrogen peroxide, although it is to be understood that other oxidizers could be utilized to remove other metal stains using the same guiding principle. In yet another aspect, the chemical method to remove silver stain described herein could additionally include reducing agents such as dithiothreitol (DTT) to be applied before alkylation prior to in-gel digestion.

In another aspect of the invention, silver stain can be removed with voltage to oxidize the silver to a water soluble ion.

### BRIEF DESCRIPTION OF THE DRAWINGS

FIG. 1A-1C depict the effects of destaining with hydrogen peroxide (FIG. 1A), destaining with Farmer's reducing reagents (FIG. 1B), and no destaining (FIG. 1C) on MALDI-TOF-MS peptide mass maps of bovine serum albumin.

FIG. 2A-2C depict the effects of destaining with hydrogen peroxide and silver restaining. FIG. 2A depicts a gel stained according to the method of Shevchenko et al. (Shevchenko, et al. 1996. Anal Chem 68:850-858). FIG. 2B is the gel after silver stain removal using 1% hydrogen peroxide solution according to the method of the present invention. FIG. 2C is the gel restained according to the method of Shevchenko et al.

FIGS. 3A and 3B depict MALDI-TOF-MS peptide mass maps of solution digests of (FIG. 3A) control phosphorylase B and (FIG. 3B) phosphorylase B treated with 1% hydrogen peroxide. Peaks labeled with monoisotopic m/z and asterisks represent peptides containing oxidized methionine. Methionine oxidation is observed in the control and to a greater extent in the hydrogen peroxide-treated solution digest. Prior to database searching, a “deisotoping” algorithm is executed, internal mass calibration performed, and monoisotopic values determined. A total of 36 peptides were matched in FIGS. 3A and 38 in FIG. 3B.

FIGS. 4A and 4B depict comparative MALDI-TOF-MS peptide mass maps of approximately 1/50^{th} of a 50 ng BSA in-gel digest with modified bovine trypsin (Roche, 16 fmol analyzed) for a control without silver removal (FIG. 4A) and for silver removal using 25 mM ammonium bicarbonate prewash followed by 1% hydrogen peroxide in 25 mM ammonium bicarbonate (FIG. 4B).

FIG. 5A-5C depict comparative MALDI-TOF-MS peptide mass maps of 10 ng in-gel digested BSA ( 1/10^{th} or 15 fmol analyzed) for a control without silver removal (FIG. 5A), silver removal using Farmer's reducing solution according to Gharahdaghi et al. (Gharahdaghi, et al. 1999. Electrophoresis 20:601-605) (FIG. 5B), and silver removal using 25 mM ammonium bicarbonate prewash followed by 1% hydrogen peroxide in 25 mM ammonium bicarbonate (FIG. 5C).

FIG. 6A-6E depict application of hydrogen peroxide-mediated silver removal to proteins extracted from a model legume, Medicago truncatula, separated by 2D-PAGE, and visualized using silver staining according to Shevchenko et al. (Shevchenko, et al. 1996. Anal Chem 68:850-858). Protein spots were excised, silver removed using hydrogen peroxide, in-gel digested, and peptide mass mapping using MALDI-TOF-MS.

### DETAILED DESCRIPTION

A method for stain removal of silver, other group 1B metals or other transition metals used as stains (e.g., gold, copper, or zinc) has now been found which utilizes an oxidizer capable of oxidizing the transition metal stain to form a water soluble substance which can easily be washed from the electrophoresis material. Hydrogen peroxide (H₂O₂) is a preferred oxidizer for this destaining method. Using the destaining method of the present invention, electrophoresis gels previously stained with a transition metal are destained prior to in-gel enzymatic digestion to increase the detectability of peptides during subsequent mass spectrometry by enhancing the sensitivity and sequence coverage of the resulting peptide mass maps.

The destaining method of the present invention can remove from electrophoresis materials silver, other group 1B metals or other transition metals used as stains such as gold, copper, or zinc. In a preferred use, the destaining method of the invention described herein removes silver. Because the other group 1B metals and zinc are negative staining techniques, destaining removes background stain which may enhance peptide mass mapping. Total destaining of silver or other 1B metals also may be desirable to allow restaining with any of the alternate staining techniques known in the art, e.g., fluorescent dyes. It is to be understood that, unless specified otherwise, the term “silver” as used herein in reference to the destaining method of the present invention is merely representative of the transition metals for which stain removal is possible.

The destaining method of the present invention can remove transition metal stains from proteins, peptides, DNA, or RNA separated or isolated in polyacrylamide (e.g., PAGE) or sodium dodecyl sulfate polyacrylamide gels (SDS-PAGE), agarose, or other gel materials. It is also useful for destaining proteins, peptides, DNA, or RNA blotted onto membranes (for example, PVDF, cellulose, nitrocellulose, or nylon) that have been stained with silver, other group 1B metals, or other transition metals. This method also can destain tissues visualized with silver, other group 1B metals, or other transition metals. It is to be understood that, unless specified otherwise, the term “PAGE gel” as used herein is merely representative of a stained material affected by the destaining method of the present invention.

The destaining method disclosed herein can be used to provide beneficial effects for all ionization techniques used to mass analyze protein and peptides. Exemplary ionization techniques benefiting from the destaining method of the present invention include, but are not limited to, MALDI-TOF-MS, electrospray ionization (ESI-MS), atmospheric pressure chemical ionization (APCI-MS), nanospray ESI and APCI, thermospray ionization (TSP-MS), fast atom bombardment (FAB-MS), both liquid and solid secondary ion mass spectrometry (SIMS and LSIMS), plasma desorption ionization (PDMS), photoionization (PMS), electron ionization (EI-MS), and chemical ionization (CI-MS).

The destaining agent of the present invention is an oxidizer capable of oxidizing the transition metal stain to form a water soluble substance which can easily be washed from an electrophoresis material. Under standard state conditions, the standard reduction potential (E⁰/V) of the oxidizer must be greater than the standard reduction potential of silver [Ag⁺(aq)+e⁻→Ag(s)=0.789V]. Under non-standard conditions, E_{cell} must be greater than zero. Electrode potentials are dictated by the Nernst equation,
E=E⁰−[2.303RT/nF]log0

In the present invention, one or more of the oxidizers in Table II can be used singly or in combination to achieve the silver destaining results.

TABLE II
Oxidizers Useful Singly or In Combination
to Achieve Silver Destaining Results

| Cl₂ | + | 2 e⁻ | | | → | 2Cl | | | E⁰/V = |
|---|---|---|---|---|---|---|---|---|---|
| | | | | | | | | | 1.360 |
| ClO₄⁻ | + | 8 H⁺ | + | 8 e⁻ | → | Cl⁻ | + | 4 H₂O | E⁰/V = |
| | | | | | | | | | 1.389 |
| MnO⁴⁻ | + | 8 H⁺ | + | 5 e⁻ | → | Mn²⁺ | + | 4 H₂O | E⁰/V = |
| | | | | | | | | | 1.507 |
| N₂O | + | 2 H⁺ | + | 2 e⁻ | → | N₂ | + | H₂O | E⁰/V = |
| | | | | | | | | | 1.766 |
| H₂O₂ | + | 2 H⁺ | + | 2 e⁻ | → | 2 H₂O | | | E⁰/V = |
| | | | | | | | | | 1.776 |
| Ag^{3 +} | + | e⁻ | | | → | Ag²⁺ | | | E⁰/V = |
| | | | | | | | | | 1.80 |
| Ag²⁺ | + | e⁻ | | | → | Ag⁺ | | | E⁰/V = |
| | | | | | | | | | 1.980 |
| Cu₂O₃ | + | 6 H⁺ | + | e⁻ | → | Cu²⁺ | + | 3 H₂O | E⁰/V = |
| | | | | | | | | | 2.0 |
| S₂O₈²⁻ | + | 2 e⁻ | | | → | 2 SO4²⁻ | | | E⁰/V = |
| | | | | | | | | | 2.010 |
| HFeO⁴⁻ | + | 8 H⁺ | + | 3 e⁻ | → | Fe³⁺ | + | 4 H₂O | E⁰/V = |
| | | | | | | | | | 2.07 |
| O₃ | + | 2 H⁺ | + | 2 e⁻ | → | O₂ | + | H₂O | E⁰/V = |
| | | | | | | | | | 2.076 |
| HFeO⁴⁻ | + | 4 H⁺ | + | 3 e⁻ | → | FeOOH | + | 2 H₂O | E⁰/V = |
| | | | | | | | | | 2.08 |
| S₄O₆²⁻ | + | 2 e⁻ | | | → | 2 S₂O₃²⁻ | | | E⁰/V = |
| | | | | | | | | | 2.123 |
| O(g) | + | 2 H⁺ | + | 2 e⁻ | → | H₂O | | | E⁰/V = |
| | | | | | | | | | 2.421 |
| H₂N₂O₂ | + | 2 H⁺ | + | 2 e⁻ | → | N₂ | + | 2H₂O | E⁰/V = |
| | | | | | | | | | 2.65 |
| F₂ | + | 2 e⁻ | | | → | 2F⁻ | | | E⁰/V = |
| | | | | | | | | | 2.87 |

The preferred destaining agent of the present invention is aqueous hydrogen peroxide. In the destaining method of the present invention, a stained electrophoresis gel is treated with an aqueous hydrogen peroxide solution having a concentration from about 0.1% to about 30%; more preferably, from about 1% to about 5%; and most preferably, 1%. While the rate of silver stain removal increases as the concentration of the hydrogen peroxide solution increases, with 3% and 5% hydrogen peroxide destaining approximately twice as fast as 1% hydrogen peroxide, 1% is generally preferred for most applications to minimize the possibility of oxidizing the proteins. N₂O, O₃, and O(g) are also preferred oxidizers and have similar benefits as hydrogen peroxide in that the redox products are gases and water.

To perform the hydrogen peroxide destaining method of the present invention, an electrophoresis gel previously stained with a transition metal such as silver is treated with a hydrogen peroxide solution at an effective concentration capable of oxidizing the metal to metal ions. For example, hydrogen peroxide is a strong oxidizing agent for silver (E⁰_{cell}/V=1.776−0.789=0.789V) and readily oxidizes silver metal to silver ions in both acid and alkaline conditions as follows:
H₂O₂+2H⁺+2Ag→2H₂O+2Ag⁺ oxidizing agent in acid solution
H₂O₂+2Ag→2OH⁻+2Ag⁺ oxidizing agent in alkaline solution

Once the metal is converted to metal ions, the metal ions can be easily removed from the electrophoresis gel by washing with water or an aqueous solution comprising an MS compatible acid. While it is preferred that all metal ions are removed, it is understood that some metal ions can remain in the gel without detracting from the improvement affected by the destaining method disclosed herein. The rate of silver oxidation and removal in a basic hydrogen peroxide solution is faster than in an acidic hydrogen peroxide solution. Thus, the addition of a base compatible with PAGE and mass spectrometry is preferred for rapid destaining. A preferred base is ammonium bicarbonate. Use of hydrogen peroxide at relatively high pH values (approximately >13) should be avoided due to hydrolysis of the acrylamide and bisacrylamide polymer at such a high pH range.

The hydrogen peroxide mediated silver oxidation method of the present invention can lead to the oxidation of methionine in proteins and peptides. However, this does not interfere with the identification of proteins/peptides, and the protein identification program MS-Fit (Baker, P. R. and Clauser, K. R. available at http://prospector.ucsf.edu) can be used to account for the theoretical mass shifts correlating to resulting methionine oxidation. These oxidation processes have been reported to yield proteins that are more accessible to proteases (Fligiel, et al. 1986. Biomed Biochim Acta 11-12:1563-1573.)

In addition to an oxidizer, complexing agents can also be used in the present invention to enhance destaining efficiency but would require additional washings to remove the additional ionic species. Examples include, but are not limited to, complexing agents such as ammonia (NH₃), hydroxide (OH), halides, thiosulfates, thiocyanate (SCN⁻), diamines, ethylenediamines, diethylenetriamines, ethylenediaminetetracetic acid (EDTA), Fe(CN)₆³⁻ salts, oxalates, quinones, pyridine, pyrimidines, and imidazole. More generally, complexes containing atoms with nonbonded electrons such as oxygen, nitrogen, or sulfur, pi electron systems, or negatively charged counter ions could be included in the method as complexing agents. The addition of ammonia has also been shown to increase the rate of the hydrogen peroxide destaining method of the present invention. The use of volatile complexation agents is preferred as they are more compatible with mass spectrometry analysis.

An exemplary stepwise protocol for silver stain removal prior to in-gel digestion and mass spectrometric analysis of proteins in PAGE gels is given in Table III.

TABLE III
Exemplary Protocol for Hydrogen Peroxide Silver Stain Removal*

| Step | Repeats | Time | Solution | Purpose |
|---|---|---|---|---|
| 1 | 2× | 5 min | water | Remove acid and PAGE buffers |
| 2 | 2× | 5 min | 25 mM NH₄HCO₃ | pH adjustment and silver complexation |
| 3 | 1× | <10 min* | 1% H₂O₂ in 25 mM NH₄HCO₃ | Silver oxidation and removal |
| 4 | 2× | 5 min | water | excess H₂O₂ and Ag⁺ removal |
| 5 | 1× | 5 min | 1% formic acid** | lower pH of gel band/spot |
| 6 | 1× | 5 min | water/acetonitrile (50%:50%) | Sequential dehydration of gel band/spot |
| | | | with 1% formic acid | |
| 7 | 1× | 10 min | acetonitrile | Dehydration of gel band/spot |

*Recommended volumes are 25 μL for 1 mm diameter gel plugs and 50 μL for gel bands.
**An acidic wash prior to gel band/plug dehydration is recommended to minimize amount of trypsin autolysis upon rehydration.

The hydrogen peroxide destaining method of the present invention is compatible with in-gel digestion using digestion agents including but not limited to modified porcine trypsin and modified bovine trypsin, chymotrypsin, elastase, and plasmin, Asp-N, Glu-C or other desirable proteases.

By employing the hydrogen peroxide destaining method of the present invention, one can obtain peptide mass maps (e.g., MALDI-TOF-MS) from in-gel digested proteins using mass spectrometry that have an increased number of detectable peptides and increased intensity of the peptide signals over similar methods utilizing no destaining or the previously reported destaining methods. Hydrogen peroxide destaining also provides other advantages over destaining with the Farmer's reducer method: (1) the peroxide oxidation products of hydrogen peroxide destaining (silver ions and water) do not introduce additional ionic components into the system that must be removed by additional extensive washing, (2) hydrogen peroxide solutions are less toxic than the Farmer's reducer reagents; (3) hydrogen peroxide solutions are more stable and can be stored for reasonable periods of time unlike the Farmer's reducer reagents which must be prepared immediately prior to use; and (4) hydrogen peroxide solutions are more amenable for automated digestion systems because only a single, stable hydrogen peroxide solution is required.

Disulfide reduction followed by alkylation is an optional and common procedure in the protocol described herein. It is probable that hydrogen peroxide oxidizes certain amino acids such as cysteine and methionine. In order to reduce amino acids such as cysteine and methionine back to their thiol form, the common practice of reducing with dithiothreitol (DTT) or other reducing agents followed by alkylation prior to in-gel digestion could reverse amino acid oxidation caused by hydrogen peroxide (Shevchenko, et al. 1996. “Mass Spectrometric Sequencing of Proteins from Silver-Stained Polyacrylamide Gels,” Anal Chem 68:850-858). It is also common practice to reduce and alkylate prior to two-dimension PAGE analysis, and this approach could also be utilized to minimize cysteine oxidation of protein products, if desired.

In addition to the chemical method to remove silver stain described herein, an electrical method can also be used to oxidize the silver to a water soluble ion. In a preferred method to oxidize and remove the silver stain, a voltaic cell is employed by inserting an electrode (for example, a platinum wire) into a gel plug. Next, the gel plug is partially or wholly submerged into a solution that would provide electrical continuity with an appropriate counter electrode. A voltage of sufficient strength to oxidize the silver ion is then applied to the electrodes. This method of using voltage to oxidize and remove silver stain provides an advantage over other staining methods in that it can be easily automated.

### EXAMPLE 1

### Comparison of Silver Destaining Methods

The hydrogen peroxide silver destaining method of the present invention was compared to the Farmer's reducer method and no destaining using model proteins bovine serum albumin (BSA), myoglobin, and glycogen phosphorylase, each separated by one-dimensional polyacrylamide gel electrophoresis followed by MALDI-TOF-MS mass analysis.

Several PAGE gels loaded with 10, 20, 50, and 100 micrograms of bovine serum albumin were prepared. One-dimensional PAGE was performed according to the procedure of Laemmli (Laemmli, U.K. 1970. “Cleavage of structural proteins during the assembly of the head of bacteriophage T4” Nature 227:680-685) using a Novex X Cell II gel apparatus. Two-dimensional PAGE was performed according to the procedure of O'Farrell (O'Farrell, P. H. 1975. “High resolution two-dimensional electrophoresis,” J. Biol Chem 250:4007-4021) with immobilized pH gradients (IPG) for the first dimension (Görg, et al. 1988. “The current state of two-dimensional electrophoresis with immobilized pH gradient,” Electrophoresis 9:531-546).

Silver staining of the PAGE gels was performed using a modification of the procedure described by Blum, et al. (Blum, et al. 1987. “Improved silver staining of plant proteins, RNA and DNA in polyacrylamide gels,” Electrophoresis 8:93-99). The gels were fixed in 50% methanol/12% acetic acid for a minimum of 1 hour followed by three separate washes with 50% ethanol and water. The gels were pretreated with 0.2 g/L of Na₂SO₃. 5H₂O for 1 minute. The gel was then impregnated with AgNO₃ (2 g/L) for 20 minutes. After incubation with silver, the gel was rinsed twice for 20 seconds each with water. The gel was then developed in a solution containing sodium carbonate (60 g/L), 0.5 milliliters of 37% HCOH/L, and 4 mg/L of Na₂SO₃.5H₂O until the desired image intensity was achieved (approximately within 10 minutes). The gels were then rinsed twice for 2 minutes in water and the staining stopped with an aqueous solution of 50% methanol/12% acetic acid. The silver stained PAGE gels were stored in water prior to enzymatic digestion.

A set of silver stained PAGE gels was destained by covering each gel with approximately 30-50 microliters of 1% hydrogen peroxide and incubated at room temperature with occasional vortexing until the brownish color of the silver metal disappeared from the gel. The remaining solution after destaining was decanted and the gel was then washed twice for 5 minutes with water. The gels were cut into small pieces, dehydrated with changes of acetonitrile until the gel pieces became opaque white, and then dried in a vacuum centrifuge for 30 minutes. All residual water and hydrogen peroxide were removed during vacuum centrifugation.

A set of silver stained PAGE gels was destained according to the procedure of Gharahdaghi, et al. (Gharahdaghi, et al. 1999. “Mass spectrometric identification of proteins from silver-stained polyacrylamide gel: a method for the removal of silver ions to enhance sensitivity,” Electrophoresis 20:601-605). Each gel was covered with approximately 30-50 microliters of a Farmer's reducer working solution (1:1 ratio of 30 mM potassium ferricyanide and 100 mM sodium thiosulfate) and incubated at room temperature with occasional vortexing until the brownish color of the silver metal disappeared from the gel. Each gel was then washed repeatedly with water to stop the reaction and remove excess reagents. Next, the gel was covered with approximately 30-50 microliters of 200 mM ammonium bicarbonate for 20 minutes and then decanted. The gels were cut into small pieces, dehydrated repeatedly with changes of acetonitrile until the gel pieces became opaque white, and then dried in a vacuum centrifuge for 30 minutes.

Each set of gel pieces treated with 1% hydrogen peroxide, the Farmer's reducer, or the untreated control were enzymatically digested as previously described (Shevchenko, et al. 1996. “Mass spectrometric sequencing of proteins silver-stained polyacrylamide gels,” Anal Chem 68:850-858), by incubating the gels overnight at 37° C. with 5-10 ng/microliter of trypsin and 50 mM ammonium bicarbonate. The resultant peptides were extracted three times from the gel pieces using 10-20 microliters of 5% trifluoroacetic acid in 50% acetonitrile, and the peptide extracts were concentrated to 4-5 microliters.

Positive ion MALDI-TOF-MS analyses were performed using a PE Biosystems Voyager DE-STR and α-cyano-4-hydroxycinnamic acid matrix similar to the procedure of Gharahdaghi et al. (Gharahdaghi, et al. 1999. “Mass spectrometric identification of proteins from silver-stained polyacrylamide gel: a method for the removal of silver ions to enhance sensitivity,” Electrophoresis 20:601-605). Peptide masses were measured at an instrument resolution of approximately 10,000 over the mass range of 850-6000 Da.

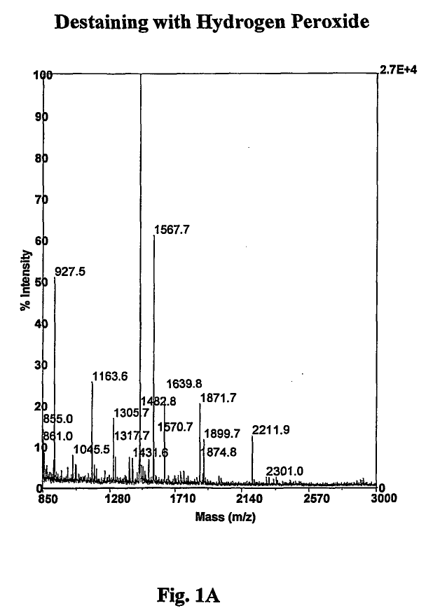

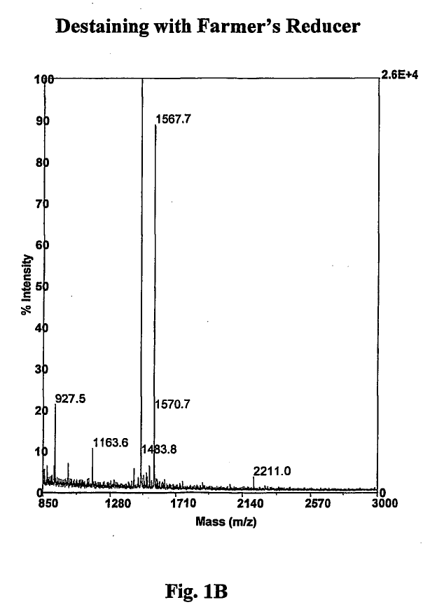

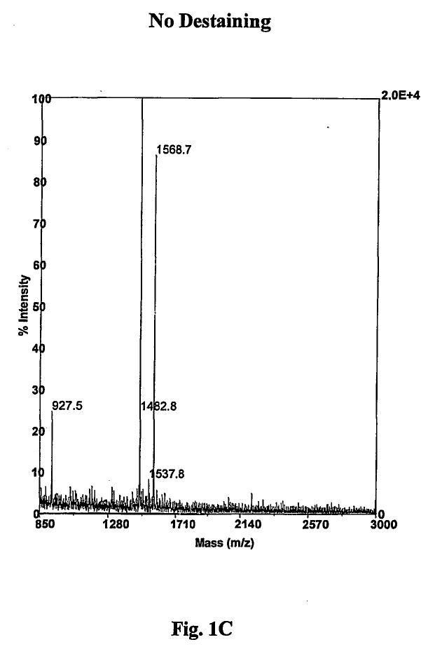

The results are presented in FIG. 1A-1C. The hydrogen peroxide destaining method of the present invention (FIG. 1A) provided a significant improvement in sequence coverage and in sensitivity of mass analysis over the Farmer's reducer destaining method (FIG. 1B), as evidenced by the increased number of observable peptides in FIG. 1A over FIG. 1B. The percent coverage of the primary amino acid sequence was calculated to be 6.0% by weight for the untreated control, 9.3% by weight using the Farmer's reducer destain, and 14.3% by weight using hydrogen peroxide destain. Thus, the observed peptide abundances were increased by over 50% after silver removal using hydrogen peroxide in comparison to the untreated (not destained) control. Although the results demonstrated in FIGS. 1B and 1C demonstrate that treating silver stained PAGE gels with the Farmer's reducer method resulted in improved sensitivity and sequence coverage when compared to mass analysis of samples which were not destained (FIG. 1B versus FIG. 1C), the results in FIG. 1A strikingly demonstrate the improvement over the Farmer's reducer method conferred by the method described herein.

### EXAMPLE 2

### Comparison of Silver Destaining Methods

The hydrogen peroxide silver destaining method of the present invention was used to remove silver stain from PAGE gels visualized with various silver-staining methods including silver nitrate (Shevchenko, et al. 1996. Anal Chem 68:850; Blum, et al. 1987. Electrophoresis 8:93), silver nitrate with tungstosilicic acid (Biorad Silver Stain Plus, Biorad Laboratories, Hercules, Calif.) (Gottlieb, et al. 1987. “Silver staining of native and denatured eucaryotic DNA in agarose gels” Anal Biochem 165:33-37); and Invitrogen SilverQuest™ MS-compatible stain (Invitrogen, San Diego, Calif.). Proteins extracted from Medicago truncatula were used as a protein source.

Proteins and Polyacrylamide Gel Electrophoresis

Standard proteins including bovine serum albumin (BSA), carbonic anhydrase, lysozyme, and phosphorylase B were obtained from Sigma Chemical Co. (St. Louis, Mo.). Proteins were separated by one-dimensional polyacrylamide gel electrophoresis using a Novex Xcell mini-gel apparatus (NOVEX Electrophoresis GmbH, Frankfurt, Germany) and according to the procedure of Laemmli (Laemmli, U.K. 1970 “Cleavage of structural proteins during the assembly of the head of bacteriophage T4,” Nature 227:680-685).

Medicago truncatula (cultivar Jemalong A17) plants were grown in growth chambers under controlled conditions in 24-cell flats at 90% humidity with 200 μmol/m² light for 18 hours per day. Plant tissue (2 grams) was harvested, immediately frozen with liquid nitrogen, ground to a fine powder using a mortar and pestle, and proteins precipitated with trichloroacetic acid (TCA)/acetone according to Tsugita et al. (Tsugita, et al. 1994. “Separation and characterization of rice proteins,” Electrophoresis 15:708-720). The protein pellet was extracted three times with 2 mL each of the isoelectric focusing (IEF) rehydration buffer consisting of 8 M urea, 4% (3-(3-cholamidopropyl)dimethylammonio)-1-propanesulphonate (CHAPS), 100 mM dithiothreitol (DTT), 0.1% biolytes (Biorad Laboratories, Hercules, Calif.), and Tris, pH 9.5. Extracts were checked for acidity and protein concentration before they were combined.

Two-dimensional PAGE was performed according to the procedure of O'Farrell (O'Farrell, P. H. 1975. “High resolution two-dimensional electrophoresis of proteins,” J Biol Chem 250:4007-4021) using immobilized pH gradients (IPG) (Görg, et al. 2000. “The current state of two-dimensional electrophoresis with immobilized pH gradients,” Electrophoresis 21:1037-1053) for the first dimensional isoelectrical focusing (IEF) using Biorad PROTEAN IEF cell with 11 cm linear pH 3-10 IPG strips. The IPG strips were rehydrated with 300 μL of the protein solution (100 ng total protein) for 16 hours and focused at a constant current of 50 μA per strip until 25000 volt hours was reached. Focused IPG strips were equilibrated at 30° C. for 15 minutes each in reduction buffer (6 M urea, 2% sodium dodecyl sulfate (SDS), 30% glycerol, 75 mM Tris pH 8.8, 100 mM DTT) and alkylation buffer (6 M urea, 2% SDS, 30% glycerol, 75 mM Tris pH 8.8, 120 mM iodoacetamide (IAA)) before loading onto SDS PAGE gels (12% T, 18×20 cm). A 1% agarose gel was used to seal the strip on the SDS PAGE gels. Two-dimensional electrophoresis was performed using a Hoefer SE-600 gel apparatus (Amersham Pharmacia Biotech, Piscataway, N.J.) and in-house cast 12% gels. All buffers were prepared in-house except for the Tris-Gly SDS PAGE run buffer, which was diluted from a 10× stock solution purchased from Biorad Laboratories (Hercules, Calif.) to yield a final concentration of 25 mM Tris, 193 mM glycine, 0.1% SDS, pH 8.3. The SDS PAGE was performed at a constant current of 25 mA per gel and was completed in approximately 4.5 hours.

The two-dimensional PAGE electrophoresis was repeated using SDS PAGE gels of varying percent total acrylamide.

Silver Staining

The protein gels obtained were silver stained according to the methods of Shevchenko, et al. (Shevchenko, et al. 1996. Anal Chem 68:850-858) or Blum, et al. Blum, et al. 1987. Electrophoresis 8:93) or using the commercially available Biorad Silver Stain Plus (Biorad Laboratories, Hercules, Calif.) or Invitrogen SilverQues™ MS-compatible stain (Invitrogen, San Diego, Calif.).

Silver Stain Removal with Hydrogen Peroxide

The silver stained protein bands were excised and then treated with either a hydrogen peroxide solution of the present invention as described below or high purity water (control). Oxidized silver ions were removed with minimal water washes.

The protein bands, plugs, or spots (hereinafter gel band/spot) were first rinsed twice with high purity water for 10 minutes each. For silver stain removal, the gel bands/spots were covered with approximately 30-50 μL of a 1% aqueous hydrogen peroxide solution and incubated at room temperature with occasional vortexing until the brownish color of the silver metal disappeared from the gel (generally 95% completed within 5 minutes). The silver stain removal solution was decanted, and the gel bands/spots were washed twice in high purity water and once with 1% formic acid. Then, the gel bands/spots were sequentially dehydrated with a 50:50 water/acetonitrile solution containing 1% formic acid and finally with 100% acteonitrile. The gel bands/spots were dried in a vacuum centrifuge where all residual water and hydrogen peroxide were removed.

The silver stain removal procedure describe above was repeated on stained gel bands/spots using 3% and 5% hydrogen peroxide.

In-Gel digestions and MALDI-TOF-MS

The protein bands/spots were enzymatically digested in-gel according to a procedure similar to that described by Shevchenko et al. (Shevchenko, et al. 1996. Anal Chem 68:850-858) using a modified sequence grade porcine trypsin (Promega, Mannheim, Germany). The gel bands/spots were rehydrated with 8-10 ng/μL trypsin in 25 mM ammonium bicarbonate on ice for 30 minutes. After removing the excess trypsin solution, the gel band/spots were covered with 25 μL of 25 mM ammonium bicarbonate and incubated at 37° C. for 6-8 hours. The proteolytic reaction was terminated by adding 10 μL of 10% aqueous formic acid. Residual gel peptides were further extracted with a 50:50 water/acetonitrile solution containing a final concentration of 1% formic acid for 10 minutes followed by a final extraction with 100% acetonitrile for 10 minutes. All peptide extract fractions were pooled, concentrated to dryness in a vacuum centrifuge and resuspended in a 50%:50% water/acetonitrile solution containing a final concentration of 1% formic acid. Peptide solutions were mixed at 1:1 with an α-cyano-4-hydroxycinnamic acid matrix solution (10 mg/mL in 50:50 water/acetonitrile with 1% formic acid) and analyzed by positive-ion MALDI-TOF-MS. Peptide mass maps were obtained using a PE Biosystems Voyager DE-STR (PE Biosystems, Foster City, Calif.) and measured at an instrument resolution in excess of 10000 over m/z range 850-6000 Da.

For the four silver staining methods tested, the rate of silver removal differed in the following order starting with the most rapid: Biorad Silver Stain Plus>Shevchenko et al.>Blum et al.>Invitrogen SilverQuest™. The rate of silver stain removal also increased as the concentration of the hydrogen peroxide solution increased, with 3% and 5% hydrogen peroxide destaining approximately twice as fast as 1% (data not shown). The rate of silver removal was also dependent on the rate of diffusion in the gel which is proportional to the percent total acrylamide of the SDS PAGE gel: the greater the concentration of acrylamide in the SDS PAGE gel, the slower the rate of silver stain removal (data not shown). The quality of resultant peptide mass maps was high, and the proteins were successfully identified by database searching. The peptide identifications correlated with previous analyses performed using Coomassie staining. However, silver stain removal allowed identification of proteins at lower concentrations.

### EXAMPLE 3

### Effects of Silver Destaining on In-Gel Proteins

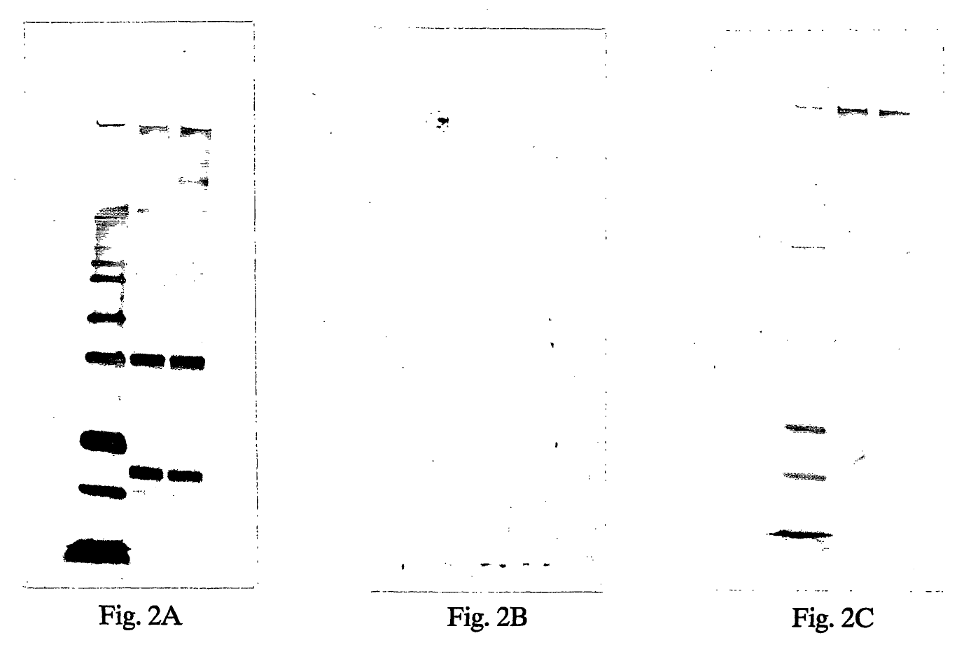

To determine if the hydrogen peroxide silver destaining method of the present invention is detrimental to in-gel isolated proteins, a representative protein gel was prepared, silver stained (Shevchenko, et al. 1996. Anal Chem 68:850-858), destained with hydrogen peroxide and then restained according to the procedures given in Example 2. The results showed that the protein gel could be silver stained, destained, and successfully restained after destaining with hydrogen peroxide without loss of protein due to oxidation or hydrolysis during hydrogen peroxide treatment (FIG. 2A-2C).

### EXAMPLE 4

### Hydrogen Peroxide Oxidation of Proteins

The increase in protein or peptide mass due to methionine, tryptophan, and cysteine oxidation by hydrogen peroxide exposure has been previously reported (Lundblad, R. L. 1991. Chemical Reagents for Protein Modifications, 2^{nd} ed, CRC Press: Boca Raton, Fla., chapter 6 and 59; Aitken, A. and Learmonth, M. 1998. Chemical Modification of Proteins and Peptide Production and Purification in Protein Protocols on CD-ROM, J. M. Walker, ed., Humana Press, chapter 7, 7.2; Steffek, R. P. and Thomas, M. J. 1991. “Hydrogen peroxide modification of human oxyhemoglobin,” Free Radical Res. Commun 12/13:489497). To determine the effects of hydrogen peroxide on the possible oxidation and hydrolysis of intact proteins or peptides using the method of the present invention, intact proteins (carbonic anhydrase, BSA, and phosphorylase B) were incubated for one hour at room temperature with 1% hydrogen peroxide. The hydrogen peroxide-treated proteins were then compared against untreated controls by MALDI-TOF-MS. In general, the intact protein m/z values were shown to increase by 200 to 400 Da after incubation with hydrogen peroxide. The mass increases were attributed to oxidation of the intact protein.

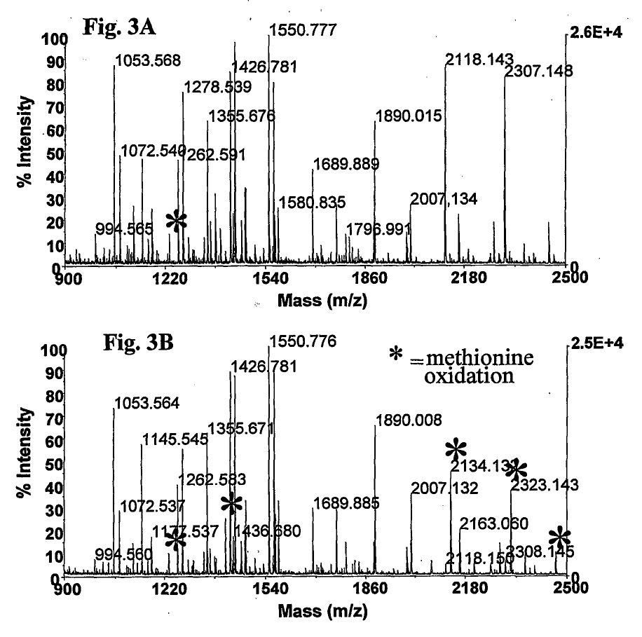

Similarly, digested protein solutions were incubated with hydrogen peroxide solutions and the resultant effects monitored with MALDI-TOF-MS peptide mass mapping (FIGS. 3A and 3B). The resulting peptide mass maps indicated enhanced methionine oxidation in the hydrogen peroxide treated proteins compared to untreated controls. Further, phosphorylase B showed greater oxidation than BSA or lactate dehydrogenase. Analyzing MALDI-TOF-MS peptide mass maps of a solution digest of control phosphorylase B indicated one peptide containing oxidized methionine, compared to four peptides containing oxidized methionine in the solution digest of phosphorylase B treated with 1% hydrogen peroxide. Prior to database searching, a deisotoping algorithm was executed, internal mass calibration performed, and monoisotopic values determined. Under these conditions, 36 peptides were matched for the control phosphorylase B protein compared to 38 peptides for the hydrogen peroxide treated phosphorylase B sample.

### EXAMPLE 5

### Effect of pH on Hydrogen Peroxide Silver Stain Removal

The effect of pH on silver stain removal rates was determined using the destaining method of the present invention as given in Example 2 on BSA (at 100 ng and 50 ng) containing PAGE gels stained according to the method of Shevchenko et al. (Shevchenko, et al. 1996. Anal Chem 68:850-858).

The results are summarized in Table IV. In general, the rate of silver stain removal by the hydrogen peroxide oxidation method of the present invention was considerably slower in acidic solutions, whereas basic solutions increased the rate of silver oxidation and removal. At approximately the same basic pH, the rate of silver removal increased by more than a factor of three when ammonium hydroxide solution was used in place of a sodium hydroxide solution. Thus, the presence of ammonia can enhance silver oxidation and removal.

TABLE IV
Effects of pH on the Rate of Hydrogen
Peroxide Mediated Silver Stain Removal

| | | 1% H₂O₂ |
|---|---|---|
| Solution | pH | Destain Time (min:sec)* |
| 1% Formic acid | 2.3 | 18:00 |
| 1 mM HCl | 3.3 | 14:48 |
| MilliQ H₂O (high purity water) | 5.0 | 4:30 |
| 25 mM NH₄HCO₃ | 8.0 | 3:00 |
| 5 mM NaOH | 10.8 | 3:00 |
| 1% NH₄OH | 10.9 | 0:45 |

*Silver destain times measured for 100 ng Mark12 Standard band Lysozyme visualized by the silver staining method of Shevchenko et al. (Shevchenko, et al. 1996. Anal Chem 68: 850-858).

Hydrogen peroxide alone is sufficient to remove silver stain from proteins; however, the results in Table IV indicate that pH is not the only factor affecting the rate of hydrogen peroxide mediated silver removal. The presence of ammonia lowers the oxidation potential of the silver metal. In fact, the reduction potential for silver diamine complexes [0.37 eV for Ag(NH₃)₂] is known to be lower than that of the free metal [Ag⁺→Ag⁰, 0.7796 eV].(Rabilloud, T. 1990. Electrophoresis 11:785-794.). The effects of complexation agents on silver removal were probed further by incubation of gel bands/spots in ammonium bicarbonate solutions at various stages during silver removal using hydrogen peroxide. Ammonium bicarbonate is compatible with mass spectrometry and is an established component of protein digestion methods for peptide mass mapping.

These results are summarized in Table V. In one study, the destaining treatments included: a prewash with high purity water and a wash with 1% hydrogen peroxide in water; a prewash with high purity water and a wash with 1% hydrogen peroxide in ammonium bicarbonate (25 mM NH₄HCO₃); a prewash with ammonium bicarbonate and a wash with 1% hydrogen peroxide in water; or a prewash with ammonium bicarbonate and a wash with 1% hydrogen peroxide in ammonium bicarbonate. All prewash and hydrogen peroxide oxidation steps were performed twice for 5 minutes. These results show a progressive improvement in destaining time through the presence of ammonium bicarbonate. Ammonium bicarbonate has the added benefit of being volatile and compatible with mass spectrometry. Although ammonium bicarbonate is the preferred means of complexation and enhancement of silver removal, alternative complexation reagents, as described above, could also be utilized.

TABLE V
Influence of Ammonium Bicarbonate on the Rate
of Hydrogen Peroxide Silver Stain Removal

| | Destain Time (min:sec) | |
|---|---|---|
| | Protein conc: | Protein conc: |
| Destain Treatment | 100 ng BSA | 50 ng BSA |
| Water prewash followed by 1% hydrogen | 20:00 | 15:08 |
| peroxide in water | | |
| Water prewash followed by 1% hydrogen | 3:20 | 2:05 |
| peroxide in 25 mM NH₄HCO₃ | | |
| 25 mM NH₄HCO₃ prewash followed by | 0:48 | 0:40 |
| 1% hydrogen peroxide in water | | |
| 25 mM NH₄HCO₃ prewash followed by | 0:30 | 0:20 |
| 1% hydrogen peroxide in 25 mM NH₄HCO₃ | | |

### EXAMPLE 6

### Effect of Silver Removal Using Hydrogen Peroxide on MALDI-TOF-MS

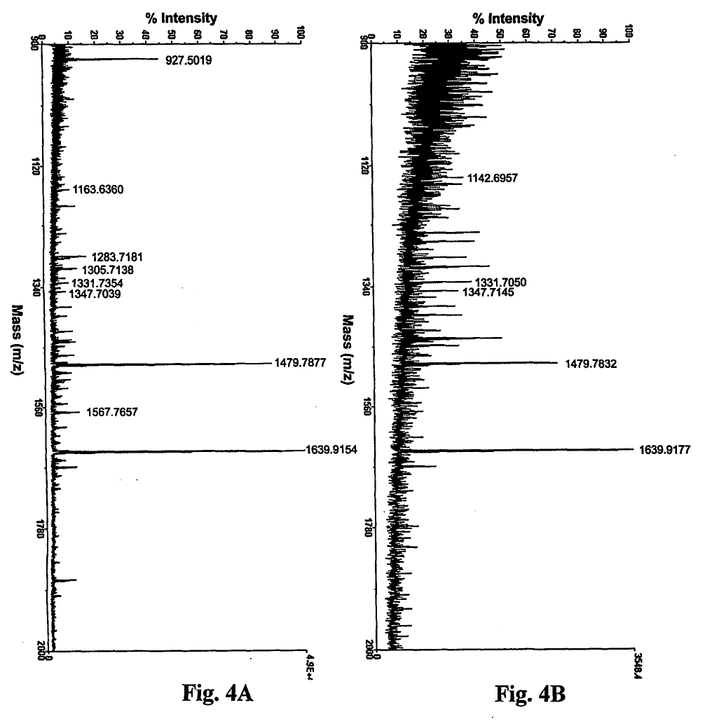

Silver stain removal using hydrogen peroxide improves MALDI-TOF-MS peptide mass mapping, with increases in both protein sequence coverage and peptide abundance. A 50 ng BSA sample was separated by one-dimensional PAGE and silver stained according to Shevchenko et al. (Shevchenko, et al. 1996. Anal Chem 68:850-858) but not reduced or alkylated to illustrate sensitivity of silver removal. With silver removal using a 25 mM ammonium bicarbonate prewash followed by 1% hydrogen peroxide in 25 mM ammonium bicarbonate or without silver removal, in-gel digestion with modified bovine trypsin (Roche, 16 fmol analyzed) was performed and MALDI-TOF-MS peptide mass maps were prepared for approximately 1/50^{th} of the 50 ng BSA sample. The results are depicted in FIGS. 4A and 4B. Comparing the MALDI-TOF-MS peptide mass maps, peptide abundance was observed to increase by a factor of 10 and sequence coverage increased by a factor of two for the hydrogen peroxide-mediated silver removal (FIG. 4B) over the control (FIG. 4A).

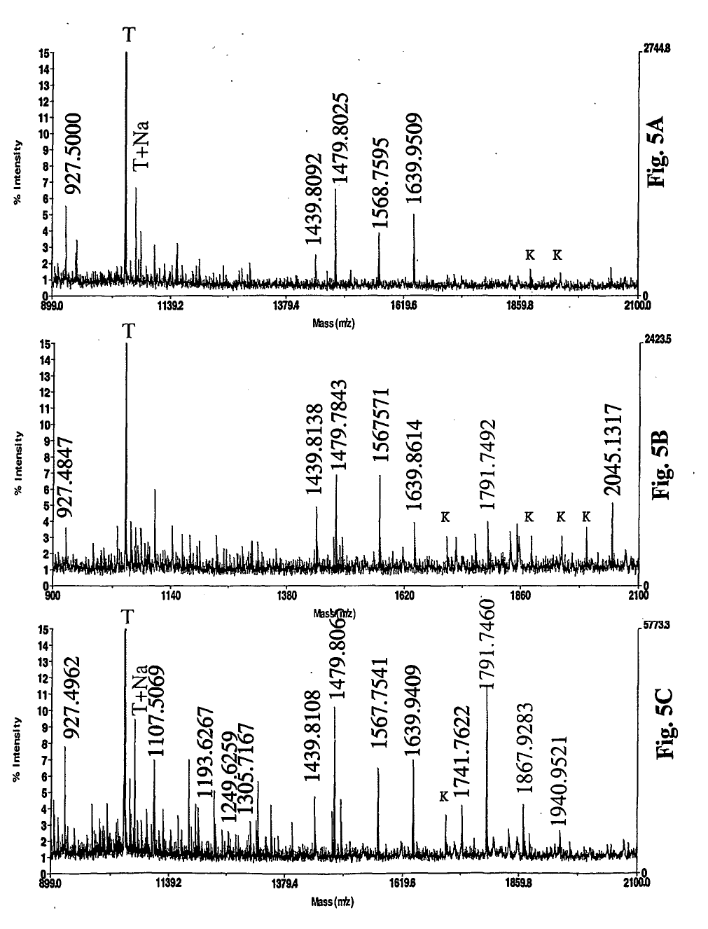

In another study, BSA samples were separated by one-dimensional PAGE, silver stained, reduced and alkylated according to Shevchenko et al. (Shevchenko, et al. 1996. Anal Chem 68:850-858) and either untreated without silver removal as a control, subjected to silver removal using Farmer's reducing solution according to Gharahdaghi et al. (Gharahdaghi, et al. 1999. Electrophoresis 20:601-605), or subjected to silver removal using 25 mM ammonium bicarbonate prewash followed by 1% hydrogen peroxide in 25 mM ammonium bicarbonate. Following in-gel digestion using modified porcine trypsin (Promega), 10 ng in-gel digested BSA, MALDI-TOF-MS peptide mass maps were prepared for approximately 1/10^{th} (15 fmol analyzed) of the 10 ng BSA sample. The comparative results are given in FIG. 5A-5C, with MALDI-TOF-MS peptide mass maps of long for a control without silver removal (FIG. 5A), silver removal using Farmer's reducing solution according to Gharahdaghi et al. (FIG. 5B), and silver removal using 25 mM ammonium bicarbonate prewash followed by 1% hydrogen peroxide in 25 mM ammonium bicarbonate (FIG. 5C). Protein sequence coverage and peptide abundances were observed to increase by 50% after silver removal using hydrogen peroxide in comparison to the untreated control. Similar, but slightly better, results were observed for the hydrogen peroxide-treated digests when compared with the Farmer's reducer silver removal. Monoisotopic m/z values are reported. Peaks labeled with K are identified as keratin-related peptides.

### EXAMPLE 7

### Application of Hydrogen Peroxide-Mediated Silver Removal to Medicago truncatula Leaf Extracts

Proteins were extracted from a model legume, Medicago truncatula, separated by 2D-PAGE, and visualized using silver staining according to Shevchenko et al. (Shevehenko, et al. 1996. Anal Chem 68:850-858) Protein spots were excised, silver removed using hydrogen peroxide, in-gel digested, and peptide mass mapped using MALDI-TOF-MS.

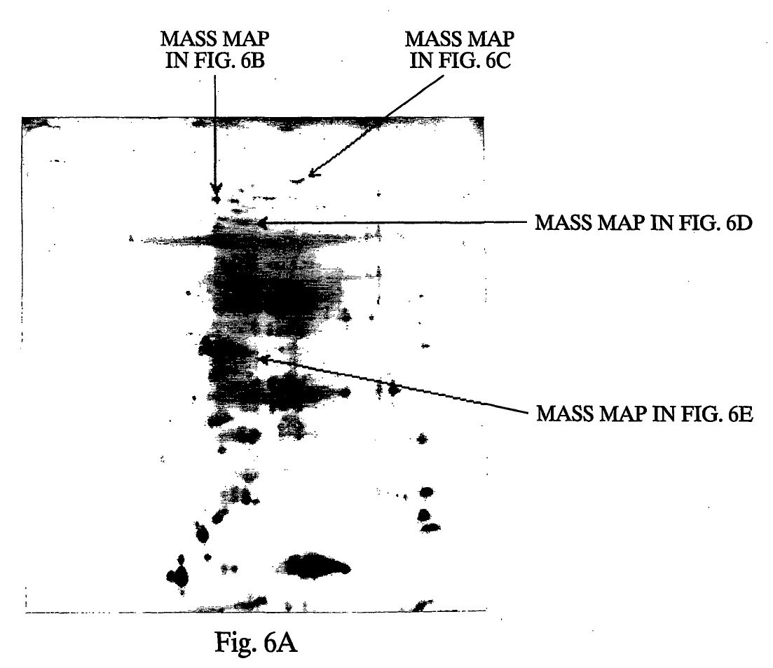

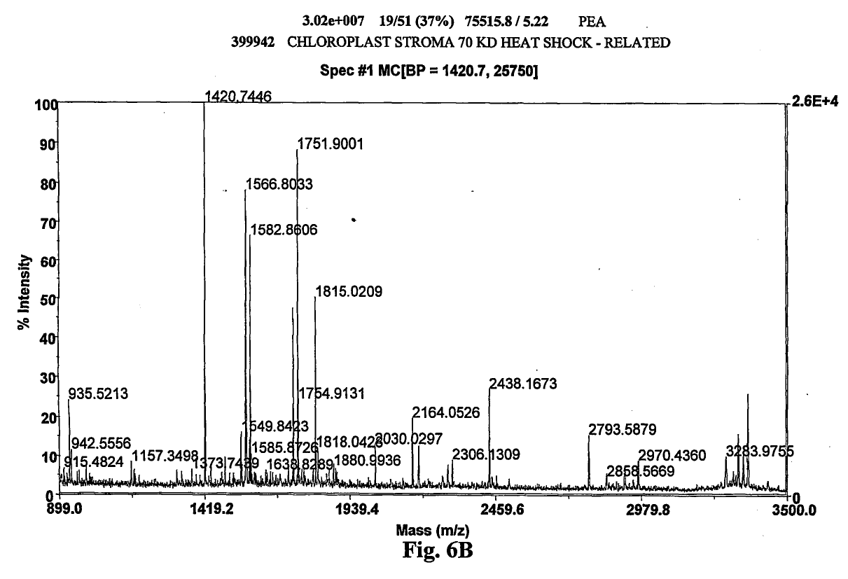

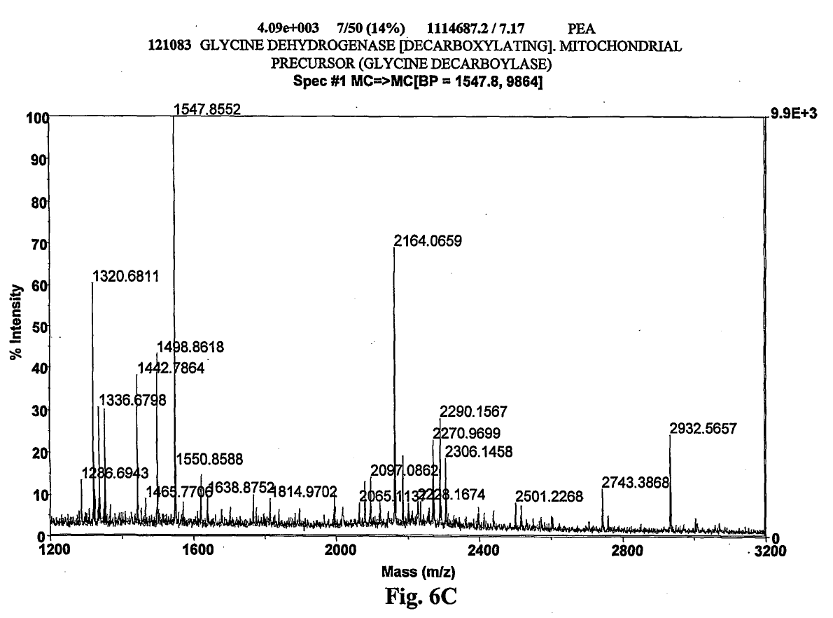

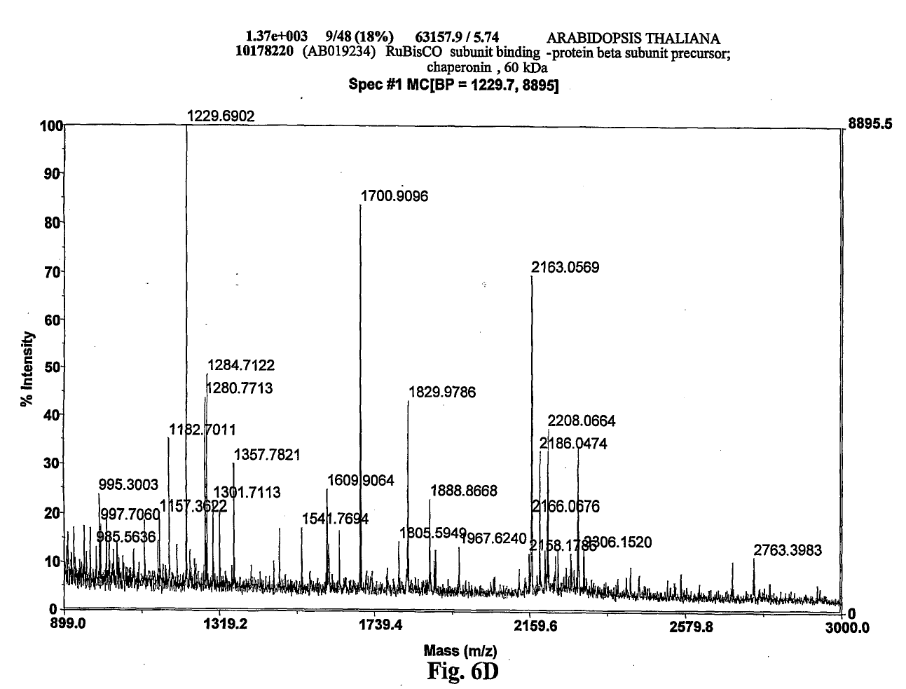

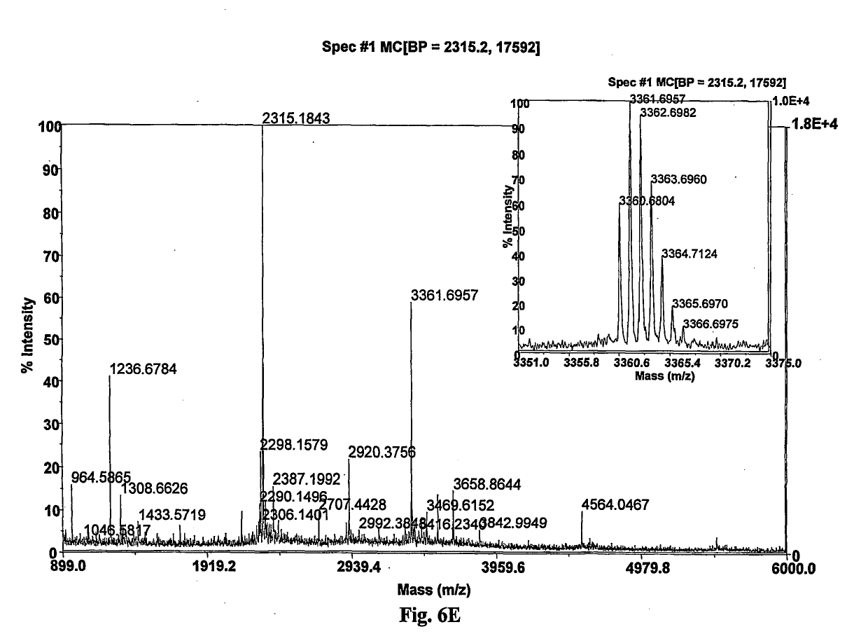

The resultant peptide mass maps are given in FIG. 6A-6E. Protein concentrations are estimated to be in the low nanogram range based on spot intensity. The quality of the peptide mass maps was high and proteins were identified using database searching. The identifications agreed with previous analyses using Coomassie staining; however, silver removal allowed protein identifications at lower concentrations.

1. A method of removing a transition metal stain from an electrophoresis material containing protein, peptide, RNA or DNA, comprising
permeating said electrophoresis material with an effective amount of a destaining composition comprising an oxidizer, said oxidizer having sufficient oxidizing capacity to oxidize at least a portion of said transition metal to form a water soluble transition metal compound without deleterious affect on said protein, peptide, RNA or DNA to form a treated electrophoresis material; and
washing said treated electrophoresis material with water to remove a portion of said water soluble transition metal compound from said treated electrophoresis material.

2. The method of claim 1, wherein said transition metal is selected from the group consisting of silver, gold, copper, zinc, other group 1B metals and other transition metals.

3. The method of claim 1, wherein said transition metal is silver.

4. The method of claim 1, 2 or 3, wherein said oxidizer is hydrogen peroxide.

5. The method of claim 4, wherein said destaining composition further comprises ammonium bicarbonate.

6. A method of removing a transition metal stain from an electrophoresis material containing protein, peptide, RNA or DNA, comprising
permeating said electrophoresis material with a pH adjusting agent to adjust the pH of said material to a basic pH less than pH 13;
permeating said electrophoresis material with a transition metal complexation composition;
permeating said electrophoresis material with an effective amount of a destaining composition comprising an oxidizer, said oxidizer having sufficient oxidizing capacity to oxidize at least a portion of said transition metal to form a water soluble transition metal compound without deleterious affect on said protein, peptide, RNA or DNA to form a treated electrophoresis material; and
washing said treated electrophoresis material with water to remove a portion of said water soluble transition metal compound from said treated electrophoresis material.

7. The method of claim 6 further comprising permeating said electrophoresis material with an effective amount of an acidic pH adjusting agent to acidify said electrophoresis material; and
permeating said electrophoresis material with an effective amount of at least one dehydrating agent to dehydrate said electrophoresis material.

8. The method of claim 6 or 7, wherein the transition metal is selected from the group consisting of silver, gold, copper, zinc, other group 1B metals and other transition metals.

9. The method of claim 6 or 7, wherein the transition metal is silver.

10. The method of claim 6 or 7, wherein said oxidizer is hydrogen peroxide.

11. The method of claim 8, wherein said oxidizer is hydrogen peroxide.

12. The method of claim 9, wherein said oxidizer is hydrogen peroxide.

13. The method of claim 10, wherein said destaining composition further comprises ammonium bicarbonate.

14. The method of claim 11, wherein said destaining composition further comprises ammonium bicarbonate.

15. The method of claim 12, wherein said destaining composition further comprises ammonium bicarbonate.

16. The method of claim 6 or 7, wherein said pH adjusting agent comprises ammonium bicarbonate.

17. The method of claim 6 or 7, wherein said complexation composition comprises ammonium bicarbonate.

18. A method of removing a transition metal stain from a tissue sample comprising
a. incubating said tissue sample with an effective amount of a destaining composition comprising an oxidizer, the oxidizer having sufficient oxidizing capacity to oxidize at least a portion of said transition metal to form a water soluble transition metal compound without deleterious affect on said tissue; and
b. washing said tissue sample with water to remove a portion of said water soluble transition metal compound from said tissue sample.

19. The method of claim 18, wherein said transition metal is selected from the group consisting of silver, gold, copper, zinc, other group 1B metals and other transition metals.

20. The method of claim 18, wherein said transition metal is silver.

21. The method of claim 18, 19 or 20, wherein said oxidizer is hydrogen peroxide.

22. The method of claim 21, wherein said destaining composition further comprises ammonium bicarbonate.

23. A method of removing a transition metal stain from an electrophoresis gel comprising
a. inserting an electrode into an electrophoresis material;
b. placing said electrophoresis material partially or wholly into an electrically conducting solution in the presence of a counter electrode to form a voltaic cell;
c. applying a voltage to said voltaic cell, said voltage of sufficient strength to oxidize said transition metal stain into a water soluble transition metal compound; and
d. washing said electrophoresis material to remove the water soluble transition metal compound from the electrophoresis material.

24. A method of removing a transition metal stain from a tissue sample comprising
a. inserting an electrode into an electrophoresis material;
b. placing said electrophoresis material partially or wholly into an electrically conducting solution in the presence of a counter electrode to form a voltaic cell;
c. applying a voltage to said voltaic cell, said voltage of sufficient strength to oxidize said transition metal stain into a water soluble transition metal compound; and
d. washing said electrophoresis material to remove the water soluble transition metal compound from the electrophoresis material.
